(19) United States
(12) Patent Application Publication
(10) Pub. No.: US 2004/0245285 A1
(43) Pub. Date: Dec. 9, 2004

(54) Toy shaped medicine dispenser

(76) Inventor: Katherine Jude McLaughlin, Naples, FL (US)

Correspondence Address: Dennis G. LaPointe, Esq., Suite 500, 17757 U.S. Hwy. 19 N., Clearwater, FL, 33764, US

(21) Appl. No.: 10/455,561

(22) Filed: Jun. 4, 2003

(51) Int. Cl. B67D 1/00

(52) U.S. Cl. 222/78; 222/386

(57) ABSTRACT

The specification and drawings describe and show various embodiments of the present invention in the form of a animal with provisions for inserting a removable syringe through a part of an animal shaped toy, such as a dog, cat, teddy bear or similar animals. The apparatus can be used to administer medicine to those orally or by injection, depending on the type of syringe used with the toy.

The invention relates to a device for dispensing medicines to those who have a fear of syringes.

It is not unusual for children to fear the sight of needles or syringes, or to have some fear or experience anxiety when having to orally take medicine. Much of this is presumed to be psychological but real in the minds of the child. The object of the invention is to provide a friendly way of administering the medicine, that is, by administering the medicine with a device that pleases the child patient.

Children generally have fun playing with toys, particularly a toy formed into an animal shaped caricature. Children also tend to feel secure with toys, especially children who are ill. Medicine taken orally, on the other hand, can have an unpleasant taste to the child. The present invention is intended to minimize the effect of such distaste and to minimize the effect of fear sometimes associated with the administration of medicine, to children, by combining the presence of an animal shaped toy with the syringe device used to administer the medicine.

The invention is an apparatus for the administration of medicine to children. It is a toy formed in the shape of an animal, within which means for administering medicine is incorporated through a portion of the toy. The means for administering medicine is removable and is typically insertable through the toy with a first end extending outside the toy on one side of the toy and a second end extending outside the toy on an opposite side of the toy.

The invention includes the ability to trigger or activate the dispensing of medicine (herein referred to as medicine dispensing activation means). This activation means is located on the first end of a syringe-like device (herein referred to as the means for administering medicine). Located on the second end of the means for administering medicine is a feature that allows the device to provide the medicine orally or by injection to the patient (herein referred to as medicine dispensing means).

As mentioned above, the means for administering medicine is typically a syringe, which can be a needle type of syringe for injections such as for flu shots and similar shots typically administered to a patient's arm. Alternatively, the medicine dispensing means on the second end of the syringe can include outlet means for ejecting medicine to be taken orally by a patient. This can be one or more apertures or outlets through which the medicine, such as cough syrup, can be administered orally to the child patient.

Preferably, the syringes exits the mouth of the animal and enters through the back side or head of the animal.

Typical of any syringe, whether for oral intake or transdermal injection, the medicine dispensing activation means on the first end of the syringe, includes plunger means. The plunger means is capable of drawing the medicine into the syringe from a source container under a vacuum and for pushing the medicine out the first end of the syringe. That is, a syringe is generally a tubular shaped two component device where the plunger is or acts like a piston in a tubular shaft. Usually a seal in the form of an o-ring or teflon ring rides along the inside walls of the shaft. With the plunger fully inserted, the dispensing end of the syringe can be placed in the container source of medicine and as the plunger is withdrawn, a vacuum created in the shaft draws the medicine into the interior of the syringe. Pushing the plunger back into the shaft drives the medicine out the outlet at the second end of the syringe for oral dispensing, or at the end of the needle if the syringe is of the needle type for injections.

In the accompanying drawings:

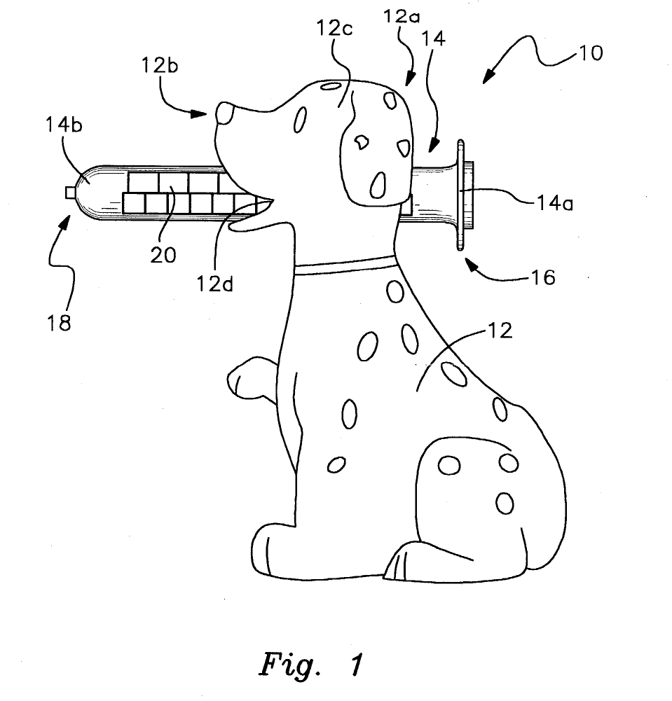

FIG. 1 is a conceptual side view of the invention using, as an example, a toy in the form of a puppy dog and a syringe for dispensing medicine or nutrients where the syringe is inserted through the back of the dog's head and exits through the mouth of the dog;

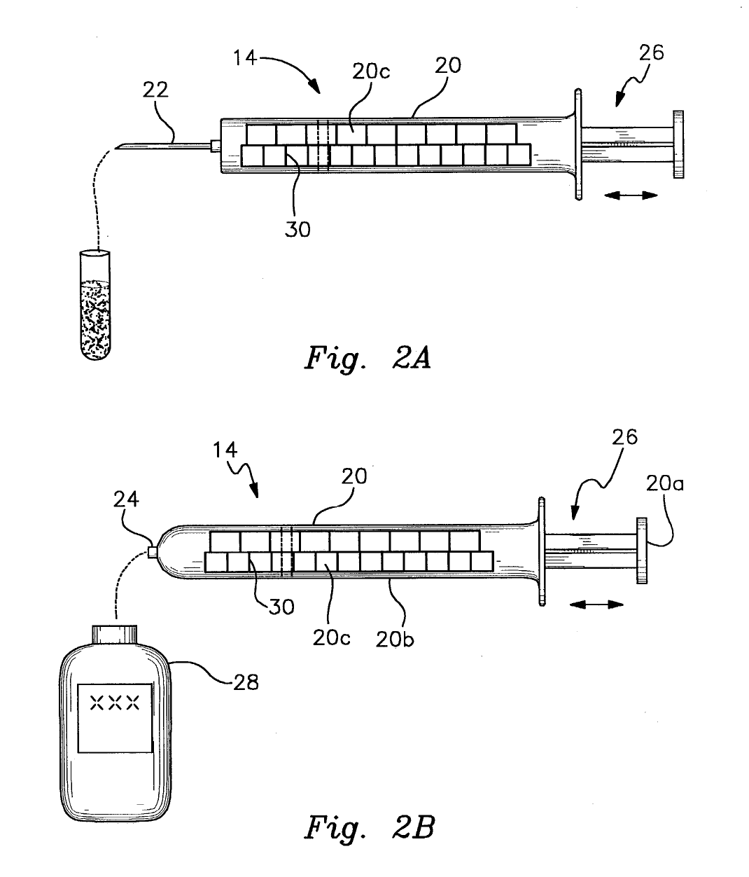

FIG. 2a is a schematic depiction representative of a needle type of syringe should the invention be used to administer an injection;

FIG. 2b is a schematic depiction representative of a type of syringe with an outlet for administering nutrients or medicine orally; and

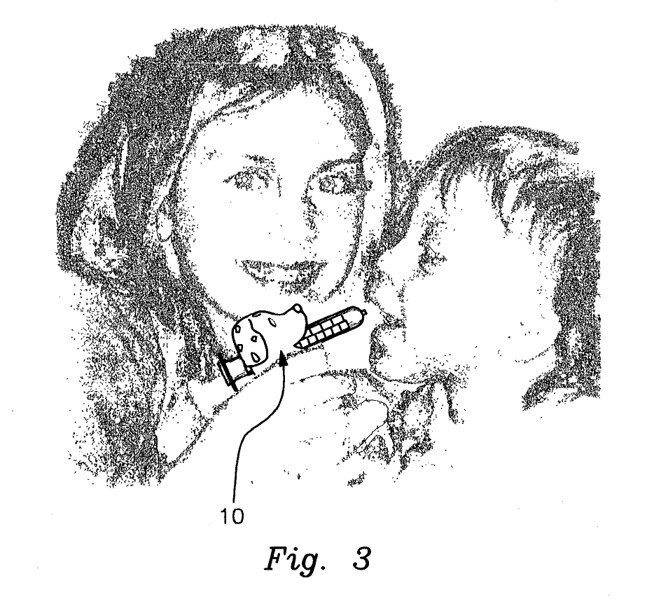

FIG. 3 is a pictorial representation of a person preparing to administer nutrients or medicine to a child, the person and child being shown with dot shading.

Referring now to the drawings, FIGS. 1, 2a-2b and 3 disclose various embodiments of the present invention, which is depicted generally as 10. It is an apparatus 10 for the administration of medicine to children comprising a toy 12 formed in the shape of an animal and removable means 14 for administering medicine. The means 14 for administering medicine is insertable through the toy 12 with a first end 14a extending outside the toy 12 on one side 12a of the toy and a second end 14b extending outside the toy 12 on an opposite side of the toy 12b.

Medicine dispensing activation means 16 is included on the first end 14a of the means 14 for administering medicine; and medicine dispensing means 18 is included on the second end 14b of the means 14 for administering medicine. The means 14 for administering medicine is typically contemplated to be a syringe 20.

The syringe 20 can include needle means 22 for injection of the medicine or nutrients in a patient. In another embodiment, the syringe 20 can instead include outlet means 24 for ejecting medicine or nutrients to be taken orally by a patient.

Most syringes 20 includes plunger means 20a, which are capable of drawing the medicine or nutrients into the syringe 20 from a source container 28 under a vacuum and for pushing the medicine or nutrients out of the syringe 20. Typically, a syringe 20 comprises an outer tubular shaped member or barrel 20b and a plunger 20a slidedly engaged within an internal chamber 20c of the outer tubular shaped member 20b. In addition, the outer tubular shaped member 20b is typically made of transparent material such as clear plastic material. Certainly, the material used will have to be capable of being cleaned/washed and/or sterilized as needed.

The transparent outer tubular shaped member 20b preferably includes graduated scale markings 30 along the outer surface of the outer tubular shaped member 20b, which are used for observing and measuring the drawn medicine or nutrients inside the internal chamber 20c to be administered.

The syringe 20 may be inserted so as to exit through any portion of the toy 12, but the preferable exit location is through the mouth 12d so the entry would then be on the back side 12b of the head 12c. The toy 12 may be a dog, a cat, a panda bear, or any other animal suitable for use as contemplated herein. The hole in the toy 12 through which the syringe 20 is inserted and removed is typically sized so that the syringe 20 fits relatively snug so it does not slide freely. In this way, the desired length of the syringe exiting the front side 12a of the toy 12 can be adjusted by the person administering the medicine or nutrients and it can stay in this location while being used, despite the pressure of pushing in the plunger 20a.

If a needle 22 is part of the syringe 20, typically the medicine or nutrients may be drawn from a source 28 such as the vile depicted in FIG. 2a. In such a case, the needle 22 is typically inserted through a rubber seal at the top of the vile 28 and the plunger 20a is pulled to draw the contents into the barrel 20b of the syringe 20. If the syringe 20 is instead one designed for oral administration, then the outlet 24 is typically an aperture which is inserted into a source or bottle 28 as depicted schematically in FIG. 2b. Again, plunger 20a is pulled to draw the medicine or nutrients into the barrel 20b and the plunger 20a is then pushed into the barrel 20b to expel the contents into the mouth of the recipient.

The scale markings 30 can be in any form, including major lines with incremental lines therebetween, indicating volumetric contents in milliliters, ounces, tablespoons, teaspoons, etc., and combinations of such measuring indicia.

It should be understood that the preceding is merely a detailed description of one or more embodiments of this invention and that numerous changes to the disclosed embodiments can be made in accordance with the disclosure herein without departing from the spirit and scope of the invention. The preceding description, therefore, is not meant to limit the scope of the invention. Rather, the scope of the invention is to be determined only by the appended claims and their equivalents.

What is claimed is:

1. An apparatus for the administration of medicine or nutrients to children comprising:
a toy formed in the shape of an animal;
removable means for administering medicine or nutrients;
the means for administering medicine or nutrients being insertable through the toy with a first end extending outside the toy on one side of the toy and a second end extending outside the toy on an opposite side of the toy;
dispensing activation means on the first end of the means for administering medicine or nutrients; and
dispensing means on the second end of the means for administering medicine.

2. The apparatus according to claim 1, wherein the means for administering medicine or nutrients is a syringe.

3. The apparatus according to claim 2, wherein the syringe includes needle means for injection of the medicine or nutrients in a patient.

4. The apparatus according to claim 2, wherein the syringe includes outlet means for ejecting medicine or nutrients to be taken orally by a patient.

5. The apparatus according to claim 2, wherein the syringe includes plunger means.

6. The apparatus according to claim 5, wherein the plunger means is capable of drawing the medicine or nutrients into the syringe from a source container under a vacuum and for pushing the medicine or nutrients out of the syringe.

7. The apparatus according to claim 2, wherein the syringe comprises an outer tubular shaped member and a plunger slidedly engaged within an internal chamber of said outer tubular shaped member, the outer tubular shaped member being made of transparent material.

8. The apparatus according to claim 7, wherein the transparent outer tubular shaped member includes graduated scale markings along the outer surface of the outer tubular shaped member, the graduated scale markings for observing and measuring the drawn medicine or nutrients inside said internal chamber to be administered.
